(19) United States
(12) Patent Application Publication
(10) Pub. No.: US 2012/0032103 A1
(43) Pub. Date: Feb. 9, 2012

(54) HIGH-TEMPERATURE-STABLE AND MOISTURE-STABLE MATERIALS WHICH HAVE IMPROVED INSULATION PROPERTIES AND ARE BASED ON FOAMS AND DISPERSE SILICATES

(75) Inventors: TATIANA ULANOVA, Ludwigshafen (DE); Sabine Fuchs, Mannheim (DE); Bernhard Schmied, Frankenthal (DE); Klaus Hahn, Kirchheim (DE); Murray Orpin, Herefordshire (GB)

(73) Assignee: BASF SE, Ludwigshafen (DE)

(21) Appl. No.: 13/204,983

(22) Filed: Aug. 8, 2011

Related U.S. Application Data
(60) Provisional application No. 61/371,753, filed on Aug. 9, 2010.

(51) Int. Cl. E04B 1/78; B05D 7/02; B29C 67/20

(52) U.S. Cl. 252/62; 264/126; 427/222

(57) ABSTRACT

The invention relates to coated foam particles, processes for producing foam moldings and the use thereof.

The invention relates to coated foam particles, processes for producing foam moldings and the use thereof.

Expanded foams are usually obtained by sintering foam particles, for example prefoamed expandable polystyrene particles (EPS) or expanded polypropylene particles (EPP) in closed molds by means of steam.

Low-flammability polystyrene foams are generally provided with halogen-comprising flame retardants such as hexabromocyclododecane (HBCD). However, permitted use as insulation materials in the building sector is restricted to particular applications. The reason for this is, inter alia, the melting and dripping of the polymer matrix in the case of fire. In addition, the halogen-comprising flame retardants cannot be used without restriction because of their toxicological properties.

WO 00/050500 A1 describes flame-retardant foams comprising prefoamed polystyrene particles which are mixed with an aqueous sodium silicate solution and a latex of a high molecular weight vinyl acetate copolymer, poured into a mold and dried in air by shaking. Here, only a loose bed of polystyrene particles which are stuck together at few points and therefore have only unsatisfactory mechanical strengths are formed.

WO 2005/105404 A1 describes an energy-saving process for producing foam moldings, in which the prefoamed foam particles are coated with a resin solution which has a lower softening temperature than the expandable polymer. The coated foam particles are subsequently fused together in a mold without application of external pressure or by after-expansion of the foam particles by means of hot steam.

WO 2007/023089 A1 describes a process for producing foam moldings from prefoamed foam particles which have a polymer coating. A mixture of a water glass solution, water glass powder and a polymer dispersion is used as preferred polymer coating. Hydraulic binders based on cement or metal salt hydrates, for example aluminum hydroxide, can optionally be added to the polymer coating. A similar process is described by WO 2008/0437 A1, according to which the coated foam particles can be dried and subsequently processed to produce fire- and heat-resistant foam moldings.

WO 00/52104 A1 relates to a fire protection coating which forms an insulating layer in the case of fire and is based on substances which comprise melamine polyphospate as blowing agent and form a foam layer and carbon in the case of fire. Information on the water resistance is not given.

WO 2008/043700 A1 relates to a process for producing coated foam particles having a water-insoluble polymer film. WO 2009/037116 relates to a coating composition for foam particles which comprises a clay mineral, an alkali metal silicate and a film-forming polymer.

Hydraulic binders such as cement set even at room temperature in an aqueous slurry in the presence of carbon dioxide. Embrittlement of the foam board can occur as a result. In addition, the foam boards produced according to the cited prior art do not withstand temperatures of above 800° C. in the case of fire and collapse in the case of fire.

The known coating compositions are in need of improved in respect of simultaneous improvement in the flame/heat resistance and their water resistance when exposed to water or at elevated humidity. Many known materials lose their original shape after a short time when exposed directly to water. In addition, if a conventional burning test is carried out, such materials frequently completely lose their structural integrity, generally leaving pulverulent mixtures which no longer satisfy technical requirements.

WO 2004/022505 describes the production of an agglomerate-free, ceramic nanoparticles dispersion which allows homogeneous and uniform distribution of the nanoparticles in the materials systems to be produced or supplemented.

EP 1043094 A1 describes an SiO₂ dispersion as binder. What is described here is a process for producing castings and potting compositions.

DE 19534764 A1 describes thin, crack-free, preferably transparent and colorless SiO₂ sheets, a process for producing them by the sol-gel process and their use, e.g. as membranes, filters, constituents of laminates or support materials with incorporated functional additives.

U.S. Pat. No. 3,783,020 describes a antihygroscopic coating of electrodes with colloidal SiO₂.

U.S. Pat. No. 4,045,593, EP-A-1537940, EP-A-468778 describe binders comprising colloidal silica for various fluxes.

Although known expanded foams frequently display a significantly improved heat resistance and water resistance, they often have the disadvantage of a relatively high density and corresponding poor insulation properties. The corresponding lambda value of these materials is frequently above 40 MW/m*K determined in accordance with DIN 52 612. The demands made of thermal insulation have increased greatly in recent years and an improvement in the insulation properties of the products is therefore absolutely necessary.

It was therefore an object of the invention to provide a high-temperature-stable material which is based on foams and offers not only good water resistance on prolonged exposure to moisture and good thermal insulation properties but also improved mechanical properties, in particular a relatively low density, and is thus easy to handle and insulates well.

The invention provides foam particles, preferably particles of a polyolefin or styrene polymer, wherein the foam particles are coated with a combination of a silicate-comprising coating, hollow microspheres and optionally nanosize SiO₂ particles.

For the purposes of the present invention, hollow microspheres are spheres whose surface comprises a polymer. The interior of the sphere is hollow and can have been filled with a blowing gas. The hollow microspheres used have a flexible outer layer, which means that the hollow microspheres can easily be compressed. They are so elastic that they withstand a plurality of load or pressure changes without bursting of their shell.

The hollow microspheres are very particularly preferably a mixture of expanded and unexpanded hollow microspheres, with the expanded hollow microspheres having been obtained by expansion of expandable hollow microspheres. Such hollow microspheres consist essentially of a gastight, polymeric outer layer and a liquid or gaseous blowing agent enclosed therein. The outer layer of the expandable or expanded hollow microspheres usually behaves as a thermoplastic. To make expansion of the expandable hollow microspheres possible, the outer layer softens on heating while at the same time the blowing agent builds up pressure. The homopolymers and/or copolymers used in the outer layer can be linear, branched or crosslinked. Copolymers comprising acrylic acid, methacrylic acid, styrene, vinylidene chloride, acrylonitrile, methacrylonitrile and the like, and also mixtures thereof, are frequently used for the outer layer.

As blowing agent, preference is given to using lower hydrocarbons such as propane, n-butane, isobutane, isopentane, n-pentane, neopentane, hexane, heptane and petroleum ether and halogenated hydrocarbons such as methyl chloride, methylene chloride, trichlorofluoromethane and dichlorodifluoromethane. The expandable hollow microspheres can be produced by known processes, as are described, for example, in U.S. Pat. No. 3,615,972. The average diameter of the expandable hollow microspheres usually increases by a factor of from 4 to 6 on expansion.

Suitable hollow microspheres in expanded, expandable and nonexpendable form are also commercially available, for example under the trade name “EXPANCEL®” from Akzo Nobel. In a particularly preferred embodiment, the expandable hollow microspheres have an outer layer of an acrylate/methacrylate copolymer and comprise from 10 to 30% by weight of blowing agent, based on hollow microsphere polymer plus blowing agent, preferably isopentane.

The hollow spheres to be used according to the invention can be produced, in particular, in the following steps:
1. Provision of an aqueous dispersion of an organic monomeric polymerizable substance and a blowing agent which preferably does not partly dissolve the polymer formed and a compound which stabilizes the dispersion.
2. The polymerizable substance with the blowing agent is then preferably dispersed in an aqueous medium to form droplets which are no larger than the size of the desired hollow spheres.
3. The dispersion formed in this way is stabilized, in particular by addition of a thickener, and the dispersion which has been stabilized in this way is subjected to a polymerization to form hollow spheres.

Hollow spheres which are particularly preferred for the purposes of the present invention have an essentially spherical shape and a diameter of preferably from 1 to 600 μm, in particular from 2 to 60 μm.

The hollow microspheres can be prefoamed before use or be used in an unprefoamed state. The hollow microspheres and the silicate-comprising coating are preferably mixed with one another and applied to the foam particles. The inventive combination of a silicate-comprising coating and hollow microspheres preferably comprises from 20 to 60 parts by weight, in particular from 25 to 40 parts by weight, of hollow microspheres per 100 parts by weight of a silicate-comprising coating.

In a preferred embodiment, the silicate-comprising coating comprises a ceramic material a) and an alkali metal silicate b). In addition, the coating preferably comprises a film-forming polymer c) and optionally nanosize SiO₂ particles d).

The ceramic materials to be used according to the invention ceramicize in the case of fire, i.e. not yet during the production of the coating compositions and foam particles according to the invention. Preferred ceramic materials are clay minerals and calcium silicates, in particular the mineral wollastonite.

In a preferred embodiment, the following are comprised:
a) from 20 to 70 parts by weight of a ceramic material
b) optionally from 20 to 70 parts by weight of an alkali metal silicate
c) from 1 to 30 parts by weight of a film-forming polymer
d) from 1 to 60, in particular from 20 to 40, parts by weight of nanosize SiO₂ particles
m) from 20 to 60, in particular from 25 to 40, parts by weight of hollow microspheres.

In a particularly preferred embodiment, the coating according to the invention consists at least essentially of the constituents a) to m) indicated in the parts by weight indicated there. In a particularly preferred embodiment, these parts by weight add up to 100%, with the resulting percentages being based on the solids content of the coating.

In a further preferred embodiment, the coating composition comprises
1. from 0 to 80 parts by weight of a ceramic material, in particular wollastonite
2. from 60 to 80 parts by weight of an aluminum silicate, in particular kaolin
3. from 30 to 50 parts by weight of sodium silicate
4. from 20 to 40 parts by weight of acrylate
5. from 20 to 50 parts by weight of unexpanded hollow microspheres, in particular Expancel® 820SLU
6. from 0 to 10 parts by weight of expanded hollow spheres, in particular Expancel® 461WE
7. from 80 to 100 parts by weight of colloidal silicon dioxide having a surface area of 50 m²/g (Levasil®) 50/50
8. from 80 to 100 parts by weight of potassium silicate.

In a preferred embodiment, from 1-2 to 2-1 parts by weight of potassium silicate are used per part by weight of sodium silicate; in a very particularly preferred embodiment, the weight ratio of sodium silicate/potassium silicate is from about 0.5:1 to 1:0.5, in particular 1:1.

In a further preferred embodiment, from 1:2 to 2:1 parts by weight of calcium silicate, in particular wollastonite, are used per part by weight of aluminum silicate; in a very particularly preferred embodiment, the ratio of aluminum silicate/calcium silicate is from about 0.5:1 to 1:0.5, in particular 1:1.

The coating composition is preferably used as an aqueous dispersion in which the water content including water bound, for example, as water of crystallization is preferably in the range from 10 to 40% by weight, in particular from 15 to 30% by weight, based on the total aqueous dispersion.

In a particularly preferred embodiment, the coating composition further comprises e) a hydrophobicizingly effective amount of a silicon-comprising compound, in particular a silicone, in particular from 0.2 to 5 parts by weight. In a particularly preferred embodiment, the constituent e) is a silicone emulsion having silicone particles of different sizes. This makes it possible to achieve particularly good penetration in porous materials.

A preferred coating composition comprises
a) from 30 to 50 parts by weight of a ceramic material
b) from 30 to 50 parts by weight of an alkali metal silicate
c) from 5 to 20 parts by weight of a film-forming polymer
d) from 5 to 10 parts by weight of nanosize SiO₂ particles
e) from 0.5 to 3 parts by weight of a silicone
f) from 5 to 40 parts by weight of an infrared-absorbing pigment
m) from 20 to 60, in particular from 25 to 40, parts by weight of hollow microspheres.

The amounts indicated above are in each case based on solids based on solids in the coating composition. The component a) to e) or a) to f) preferably add up to 100% by weight.

The weight ratio of the ceramic material to alkali metal silicate in the coating composition is preferably in the range from 1:2 to 2:1.

Suitable ceramic-forming clay minerals a) are, in particular, minerals comprising allophane Al₂[SiO₅]&O₃.nH₂O, kaolinite Al₄[(OH)₈|Si₄O₁₀], halloysite Al₄[(OH)₈|Si₄O₁₀].2H₂O, montmorillonite (smectite) (Al,Mg,Fe)₂[(OH₂|(Si,Al)₄O₁₀].Na_{0.33}(H₂O)₄, vermiculite Mg₂(Al,Fe,Mg)[(OH₂|(Si,Al)₄O₁₀].Mg_{0.35}(H₂O)₄ or mixtures thereof. Particular preference is given to using kaolin. Wollastonite is particularly suitable as ceramic-forming calcium silicate.

As alkali metal silicate b), preference is given to using a water-soluble alkali metal silicate having the composition M₂O(SiO₂)ₙ where M=sodium or potassium and n=1 to 4, or mixtures thereof.

In general, the coating composition comprises an uncrosslinked polymer having one or more glass transition temperatures in the range from −60° to +100° C. as film-forming polymer c). The glass transition temperatures of the dried polymer film are preferably in the range from −30° to +80° C., particularly preferably in the range from −10° to +60° C. The glass transition temperature can be determined by means of differential scanning calorimetry (DSC, in accordance with ISO 11357-2, heating rate 20 K/min). The molecular weight of the polymer film determined by gel permeation chromatography (GPC) is preferably below 400 000 g/mol.

The coating composition preferably comprises, as film-forming polymer, an emulsion polymer of ethylenically unsaturated monomers such as vinylaromatic monomers, such as α-methylstyrene, p-methylstyrene, ethylstyrene, tert-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, isoprene, piperylene or isoprene, α,β-unsaturated carboxylic acids such as acrylic acid and methacrylic acid, esters thereof, in particular alkyl esters such as C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide.

The polymer can optionally comprise from 1 to 5% by weight of comonomers such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The film-forming polymer is particularly preferably made up of one or more of the monomers styrene, butadiene, acrylic acid, methacrylic acid, C₁₋₄-alkyl acrylates, C₁₋₄-alkyl methacrylates, acrylamide, methacrylamide and methylolacrylamide.

Suitable polymers c) can, for example, be obtained by free-radical emulsion polymerization of ethylenically unsaturated monomers such as styrene, acrylates or methacrylates, as described in WO 00/50480.

The polymers c) are prepared in a manner known per se, for instance by emulsion, suspension or dispersion polymerization, preferably in an aqueous phase. The polymer can also be prepared by solution or bulk polymerization, optionally comminuted and the polymer particles can subsequently be dispersed in water in a conventional way. The polymerization is carried out using the initiators, emulsifiers or suspension aids, regulators or other auxiliaries customary for the respective polymerization process; polymerization is carried out continuously or batchwise at the temperatures and pressures usual for the respective process in conventional reactors.

The nanosize SiO₂ particles d) to be used according to the invention are preferably aqueous, colloidal SiO₂ particle dispersions.

Preference is given to using an aqueous, colloidal SiO₂ particle dispersion which is stabilized by means of onium ions, in particular ammonium ions such as NH₄⁺, as counterion (as an alternative also by means of alkali metal ions and/or alkaline earth metal ions). The average particle diameter of the SiO₂ particles is in the range from 1 to 200 nm, preferably in the range from 10 to 50 nm. The specific surface area of the SiO₂ particles is generally in the range from 10 to 3000 m²/g, preferably in the range from 30 to 1000 m²/g. The solids content of commercial SiO₂ particle dispersions depends on the particle size and is generally in the range from 10 to 60% by weight, preferably in the range from 30 to 50% by weight. Aqueous, colloidal SiO₂ particle dispersions can be obtained by neutralization of dilute sodium silicates by means of acids, ion exchange, hydrolysis of silicon compounds, dispersion of pyrogenic silicate or gel precipitation.

The nanosize SiO₂ particles to be used according to the invention are known per se and can be present in various forms depending on the production process. Thus, suitable dispersions can be obtained, for example, on the basis of silica sol, silica gel, pyrogenic silicas, precipitated silicas or mixtures thereof. It is known that silica sols are colloidal solutions of amorphous silicon dioxide in water, which are also referred to as silicon dioxide sols. In general, the silicon dioxide is present in the form of spherical particles which are hydroxylated on the surface.

The surface of the SiO₂— particles can have a charge which is balanced by appropriate counterions. Alkali-stabilized silica sols generally have a pH of from 7 to 11.5 and can, for example, be made alkaline by means of alkali or nitrogen bases. The silica sols can also be in the form of weakly acidic colloidal solutions. Finally, the surface of the sols can be coated, for example, with aluminum compounds.

In the case of precipitated silicas and pyrogenic silicas, the particles can be present both as primary particles and in the form of secondary particles (agglomerates). The average particle size indicated here refers, according to the invention, to the average particle size determined by means of ultracentrifugation and includes the size of primary particles and any agglomerates present.

In a preferred embodiment, silicon dioxide dispersions in which the SiO₂ particles are present as discrete, uncrosslinked primary particles are used.

The silicone e) to be used according to the invention is preferably an aqueous silicone emulsion. In a particularly preferred embodiment, the silicone emulsion comprises at least one of the following constituents: silica, diethoxyoctylsilyltrimethylsilylester, dimethylsiloxane, hydroxy-terminated aminoethylaminopropylsilsesquioxane.

An infrared-absorbing pigment (IR absorber) such as carbon black, coke, aluminum, graphite or titanium dioxide is preferably used in amounts of from 5 to 40% by weight, in particular in amounts of from 10 to 30% by weight, based on the solids in the coating, to reduce the thermal conductivity. The particle size of the IR-absorbing pigment is generally in the range from 0.1 to 100 μm, in particular in the range from 0.5 to 10 μm.

Preference is given to using carbon black having an average primary particle size in the range from 10 to 300 nm, in particular in the range from 30 to 200 nm. The BET surface area is preferably in the range from 10 to 120 m²/g.

As graphite, preference is given to using graphite having an average particle size in the range from 1 to 50 μm.

The coating composition can further comprise flame retardants such as expandable graphite, borates, in particular zinc borates, in particular ortho-borophosphate, or intumescent compositions which at relatively high temperatures, in general above 80-100° C., expand, swell or foam to form an insulating and heat-resistant foam which protects the underlying thermally insulating foam particles from the action of fire and heat.

When flame retardants are used in the polymer coating, it is also possible to achieve satisfactory fire protection using foam particles which comprise no flame retardants, in particular no halogenating flame retardants, or to make do with smaller amounts of flame retardant since the flame retardant in the polymer coating is concentrated on the surface of the foam particles and forms a solid framework under the action of heat or fire.

The coating composition can comprise, as additional additives, intumescent compositions which comprise chemically bound water or eliminate water at temperatures above 40° C., e.g. metal hydroxides, metal salt hydrates and metal oxide hydrates.

Suitable metal hydroxides are, in particular, those of groups 2 (alkaline earth metals) and 13 (boron group) of the Periodic Table. Preference is given to magnesium hydroxide, calcium hydroxide, aluminum hydroxide and borax. Particular preference is given to aluminum hydroxide.

Suitable metal salt hydrates are all metal salts which have water of crystallization incorporated in their crystal structure. Analogously, suitable metal oxide hydrates are all metal oxides which comprise water of crystallization incorporated in the crystal structure. Here, the number of molecules of water of crystallization per formula unit can be the maximum possible number or below, e.g. copper sulfate pentahydrate, trihydrate or monohydrate. In addition to the water of crystallization, the metal salt hydrates or metal oxide hydrates can also comprise water of constitution.

Preferred metal salt hydrates are the hydrates of metal halides (in particular chlorides), sulfates, carbonates, phosphates, nitrates or borates. Examples of suitable metal salt hydrates are magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrate and tin borate hydrates are particularly preferred.

Further possible metal salt hydrates are double salts or alums, for example those of the general formula: M^{I}M^{III}(SO₄)₂.12H₂O. As M^{I}, it is possible for, for example, potassium, sodium, rubidium, cesium, ammonium, thallium or aluminum ions to be present. Aluminum, gallium, indium, scandium, titanium, vanadium, chromium, manganese, iron, cobalt, rhodium or iridium, for example, can function as M^{III}.

Suitable metal oxide hydrates are, for example, aluminum oxide hydrate and preferably zinc oxide hydrate or boron trioxide hydrate.

Apart from the ceramic materials, further minerals, for example cements, aluminum oxides, vermicullite or perlite, can be additionally added to the coating. These can be introduced in the form of aqueous slurries or dispersions into the coating composition. Cements can also be applied by “dusting” to the foam particles. The water necessary for setting of the cement can then be introduced as steam during sintering.

In a preferred embodiment, the amount of coating composition to be used according to the invention per foam particle is calculated so that the weight ratio of coating composition to foam particles is from 1:2.3 to 2.3:1, in particular from 1:1.7 to 1:1.

The invention therefore further provides a process for producing coated foam particles by applying the coating composition of the invention, preferably in the form of an aqueous dispersion, to the foam particles and optionally drying the coated particles.

In a preferred embodiment, the invention provides a process for producing coated foam particles by
i) prefoaming expandable styrene polymers to give foam particles and
ii) applying the combination to be used according to the invention of a silicate-comprising coating, hollow microspheres and optionally nanosize SiO₂ particles, preferably by means of an aqueous polymer dispersion, to the surface of the foam particles and
iii) optionally drying the coated particles.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have an average particle diameter in the range from 2 to 10 mm. The bulk density of the foam particles is generally from 5 to 100 kg/m³, preferably from 5 to 40 kg/m³ and in particular from 8 to 16 kg/m³, determined in accordance with DIN EN ISO 60.

The foam particles based on styrene polymers can be obtained by prefoaming EPS to the desired density by means of hot air or steam in a prefoamer. Single or multiple prefoaming in a pressure prefoamer or continuous prefoamer enables final bulk densities of less than 10 g/l to be obtained.

To produce boards of insulation material having a high thermal conductivity, particular preference is given to using prefoamed, expandable styrene polymers which comprise athermanous solids such as carbon black, aluminum, graphite or titanium dioxide, in particular graphite, having an average particle diameter in the range from 1 to 50 μm in amounts of from 0.1 to 10% by weight, in particular from 2 to 8% by weight, based on EPS, and are known, for example, from EP-B 981 574 and EP-B 981 575.

Furthermore, the foam particles can comprise from 3 to 60% by weight, preferably from 5 to 20% by weight, based on the prefoamed foam particles, of a filler. Possible fillers are organic and inorganic powders or fiber materials, and also mixtures thereof. As inorganic fillers, it is possible to use, for example, wood flour, starch or flax, hemp, ramie, jute, sisal, cotton, cellulose or aramid fibers. As inorganic fillers, it is possible to use, for example, carbonates, silicates, barite, glass spheres, zeolites or metal oxides. Preference is given to pulverulent inorganic solids such as talc, chalk, kaolin (Al₂(Si₂O₅)(OH)₄), aluminum hydroxide, magnesium hydroxide, aluminum nitride, aluminum silicate, barium sulfate, calcium carbonate, calcium sulfate, silica, quartz flour, Aerosil®, alumina or spherical or fibrous inorganic solids such as glass spheres, glass fibers or carbon fibers.

The average particle diameter or in the case of fibrous fillers the length should be in the range of the cell size or below. Preference is given to an average particle diameter in the range from 1 to 100 μm, preferably in the range from 2 to 50 μm.

Particular preference is given to inorganic fillers having a density in the range 1.0-4.0 g/cm³, in particular in the range 1.5-3.5 g/cm³. The whiteness/brightness (DIN/ISO) is preferably 50-100%, in particular 60-98%.

The type and amount of the fillers can influence the properties of the expandable thermoplastic polymers and the particle foam moldings which can be obtained therefrom. The use of bonding agents such as maleic anhydride-modified styrene copolymers, polymers comprising epoxide groups, organosilanes or styrene copolymers having isocyanate or acid groups can significantly improve the bonding of the filler to the polymer matrix and thus the mechanical properties of the particle foam moldings.

In general, inorganic fillers reduce the combustibility. The burning behavior can be improved further by, in particular, addition of inorganic powders such as aluminum hydroxide, magnesium hydroxide or borax.

Such filler-comprising foam particles can be obtained, for example, by foaming filler-comprising, expandable thermoplastic granules. At high filler contents, the expandable granules required for this purpose can be obtained by extrusion of blowing agent-comprising thermoplastic melts and subsequent underwater pelletization, as described, for example, in WO 2005/056653.

The polymer foam particles can additionally be provided with flame retardants. For this purpose, they can comprise, for example, from 1 to 6% by weight of an organic bromine compound such as hexabromocylcododecane (HBCD) and, if appropriate, additionally from 0.1 to 0.5% by weight of bicumyl or a peroxide in the interior of the foam particles or the coating. However, halogen-comprising flame retardants are preferably not used.

The coating composition according to the invention is preferably applied in the form of an aqueous polymer dispersion to the foam particles.

The water glass powder comprised in the coating mixture leads to better or faster film formation and thus to more rapid hardening of the foam molding. If appropriate, hydraulic binders based on cement, lime cement or gypsum can additionally be added in amounts at which no appreciable embrittlement of the foam occurs.

To coat the foam particles, it is possible to use conventional methods such as spraying, dipping or wetting of the foam particles with an aqueous coating composition in conventional mixers, spraying apparatuses, dipping apparatuses or drum apparatuses.

Furthermore, the foam particles which have been coated according to the invention can be additionally coated with amphiphilic or hydrophobic organic compounds. Coating with hydrophobicizing agents is advantageously carried out before application of the aqueous coating composition according to the invention. Among hydrophobic organic compounds, particular mention may be made of C₁₀-C₃₀-paraffin waxes, reaction products of N-methylolamine and a fatty acid derivative, reaction products of a C₉-C₁₁ oxo alcohol with ethylene oxide, propylene oxide or butylene oxide or polyfluoroalkyl (meth)acrylates or mixtures thereof, which can preferably be used in the form of aqueous emulsions.

Preferred hydrophobicizing agents are paraffin waxes which have from 10 to 30 carbon atoms in the carbon chain and preferably have a melting point in the range from 10 to 70° C., in particular from 25 to 60° C. Such paraffin waxes are comprised, for example, in the BASF commercial products RAMASIT KGT, PERSISTOL E and PERSISTOL HP and also in AVERSIN HY-N from Henkel and CEROL ZN from Sandoz.

Another class of suitable hydrophobicizing agents is resin-like reaction products of an N-methylolamine with a fatty acid derivative, e.g. a fatty acid amide, amine or alcohol, as are described, for example, in U.S. Pat. No. 2,927,090 or GB-A 475 170. The melting point of these resins is generally from 50 to 90° C. Such resins are comprised, for example, in the BASF commercial product PERSISTOL HP.

Finally, polyfluoroalkyl (meth)acrylates, for example polyperfluorooctyl acrylate, are also suitable. This substance is comprised in the BASF commercial product PERSISTOL O and in OLEOPHOBOL C from Pfersee.

Further possible coating ingredients are antistatics such as Emulgator K30 (mixture of secondary sodium alkanesulfonates) or glyceryl stearates such as glyceryl monostearate GMS or glyceryl tristearate. However, it is an aspect of the process of the invention that the coating ingredients customary for coating expandable polystyrene, in particular stearates, can be used to a reduced extent or be omitted entirely without the product quality being adversely affected.

To produce foam moldings, the foam particles provided with the coating according to the invention can be sintered in a mold. Here, the coated foam particles can be used while still moist or after drying.

Drying of the coating composition applied to the foam particles can, for example, be carried out in a fluidized bed, paddle dryer or by passing air or nitrogen through a loose bed. In general, a drying time of from 5 minutes to 24 hours, preferably from 30 to 180 minutes, at a temperature in the range from 0 to 80° C., preferably in the range from 30 to 60° C., is sufficient to form the water-insoluble polymer film.

The water content of the coated foam particles after drying is preferably in the range from 1 to 40% by weight, particularly preferably in the range from 2 to 30% by weight, very particularly preferably in the range from 5 to 15% by weight. It can be determined, for example, by Karl-Fischer titration of the coated foam particles. The weight ratio of foam particles/coating mixture after drying is preferably from 2:1 to 1:10, particularly preferably from 1:1 to 1:5.

The foam particles which have been dried according to the invention can be sintered by means of hot air or steam in conventional molds to give foam moldings.

During sintering or convergination of the foam particles, the pressure can be generated, for example, by reducing the volume of the mold by means of a movable ram. In general, a pressure in the range from 0.5 to 30 kg/cm² is set here. The mixture of coated foam particles is for this purpose introduced into the opened mold. After closing of the mold, the foam particles are pressed by means of the ram, with air escaping from between the foam particles and the interstitial volume being reduced. The foam particles are bound together by the coating to form the foam molding.

Compaction by about 10-90%, preferably 60-30%, in particular 50-30%, of the initial volume is preferably effected. In the case of a mold having a cross section of about 1 m², a pressure of from 1 to 5 bar is generally sufficient to achieve this.

The mold is configured according to the desired geometry of the foam molding. The degree of fill depends, inter alia, on the desired thickness of the future molding. In the case of foam boards, a simple box-shaped mold can be used. Particularly in the case of more complicated geometries, it can be necessary to densify the bed of the particles introduced into the mold and in this way eliminate undesirable voids. Densification can be effected, for example, by shaking of the mold, tumbling movements or other suitable measures.

To accelerate setting, hot air or steam can be injected into the mold or the mold can be heated. However, a desired heat transfer media such as oil or steam can be used for heating the mold. The hot air or the mold is for this purpose advantageously brought to a temperature in the range from 20 to 120° C., preferably from 30 to 90° C.

As an alternative or in addition, sintering can be carried out continuously or discontinuously with injection of microwave energy. Here, microwaves in the frequency range from 0.85 to 100 GHz, preferably from 0.9 to 10 GHz, and irradiation times in the range from 0.1 to 15 minutes are generally used. Foam boards having a thickness of more than 5 cm can be produced in this way.

When hot air or steam having temperatures in the range from 80 to 150° C. is used or microwave energy is injected, a gauge pressure of from 0.1 to 1.5 bar is usually established, so that the process can also be carried out without external pressure and without a reduction in the volume of the mold. The internal pressure generated as a result of elevated temperatures allows the foam particles to undergo slight further expansion; these particles can, in addition to conglutination via the polymer coating, additionally fuse as a result of softening of the foam particles themselves. The interstices between the foam particles disappear in this process. To accelerate setting, the mold can in this case, too, be additionally heated as described above by means of a heat transfer medium. Injection of microwaves generally results in heating of the inorganic coating constituents which then crosslink or condense more rapidly as a consequence.

For continuous production of the foam moldings, double belt plants as are used for Production of polyurethane foams are also suitable. For example, the prefoamed and coated foam particles can be applied continuously to the lower of two metal belts, which may if appropriate have perforations, and be processed with or without compression by the coming together of the metal belts to form continuous foam boards. In an embodiment of the process, the volume between the two belts is steadily decreased, as a result of which the product is compressed between the belts and the interstices between the foam particles disappear. After a hardening zone, a continuous board is obtained. In another embodiment, the volume between the belts can be kept constant and the belts can pass through a zone with hot air or microwave irradiation in which the foam particles undergo after-foaming. Here too, the interstices disappear and a continuous board is obtained. It is also possible to combine the two continuous process variants.

The thickness, length and width of the foam boards can vary within wide limits and is delimited by the size and closure force of the tool. The thickness of the foam boards is usually from 1 to 500 mm, preferably from 10 to 300 mm. Further preferred sizes and ranges are from 10 to 200 mm, preferably from 20 to 110 mm, particularly preferably from 25 to 95 mm.

The density of the foam moldings in accordance with DIN 53420 is generally from 10 to 150 kg/m³, preferably from 20 to 90 kg/m³. The process makes it possible to obtain foam moldings having a uniform density over the entire cross section. The density of the outer layers corresponds approximately to the density of the inner regions of the foam moldings.

Comminuted foam particles from recycled foam moldings can also be used in the process. To produce the foam moldings according to the invention, it is possible to use 100% of comminuted recycled foams or to use the latter in proportions of, for example, from 2 to 90% by weight, in particular from 5 to 25% by weight, together with fresh material without the strength and the mechanical properties being significantly impaired.

Further additives which preferably make no or only a small contribution to the combustibility and/or materials which in the unfired state have a positive effect on the mechanical or thermal properties, for example vermiculite, can also be added to the coating in order to modify the mechanical and hydraulic properties.

The invention therefore further provides a process for producing foam moldings, which comprises the following steps:
a) introduction of the foam particles which have been coated according to the invention into a mold, pressing of the coated foam particles and drying, if appropriate with the aid of reduced pressure, and
b) sintering.

In a particularly preferred embodiment, foam particles which have additionally been coated with an aqueous polymer dispersion which on drying in step a) forms a water-insoluble polymer film on the foam particles are used here.

The coating compositions according to the invention are suitable for producing single or complex foam moldings such as boards, blocks, tubes, rods, profiles, etc. Preference is given to producing boards or blocks which can subsequently be sawn or cut to produce boards. Boards and blocks can, for example, be used in building and construction for insulating exterior walls. They are particularly preferably used as core layer for producing sandwich elements, for example structural insulation panels (SIP) which are used for the construction of coolstores or warehouses.

### EXAMPLES

Test methods

To test the quality of the specimens, a series of tests are carried out.

Firstly, after the test specimens have been matured for the proper time, the volume decrease in the case of fire (burning before) (test A) is determined. For this purpose, a cube having an edge length of 5 cm is sintered at 1030° C. in a muffle furnace for 15 minutes. The volume of the cube is subsequently determined again and subtracted from the initial value (“volume decrease in the burning test before exposure to water”).

In addition, the water absorption of the cube is determined (test B). For this purpose, a cube having an edge length of 5 cm is completely immersed in water at 50° C., the waterbath is stirred continuously for 24 hours and the cube is subsequently dried and weighed again to determine the proportion of the coating which has been washed out. The water in the vessel is evaporated and the residue is likewise weighed to check the washing-out loss determined above.

After the proper maturing time, the test specimen as described under A is subjected to a burning test. This gives the “volume decrease in the case of fire after exposure to water”). (burning after) (test C).

In addition, the fire resistance of the material is tested. For this purpose, a plate having dimensions of 55×55×12 cm and covered on both sides with a thin metal plate is mounted on a small-fire oven. While the standard temperature curve is run up in the furnace, the heat transmission is recorded by means of temperature sensors on the metal covering of the sandwich construction facing away from the oven (with the test specimen in the middle) until one of the two test criteria (mean: delta T>140° C. or simple value: delta T>180° C.) is exceeded. (Test D). In addition, the compressive strength in accordance with EN826, the flexural strength in accordance with EN1289 and the Lambda value of the hybrid material are measured.

### Example 1

In a glass beaker, a mixture of kaolin (26 g), water glass (11 g), Acronal® S790 Dispersion (11 g), Wollastonite® HW 7 (26 g), Betolin® (34 g), Levasil® 50/50 (34 g), Expancel® 551WE (2 g), Expancel ®820SLU (8 g) was made up. After complete homogenization, 153 g of this coating mixture was added to 78 g of prefoamed EPS spheres (density 10 g/l) and mixed well. The spheres which had coated in this way were subsequently introduced into a mold, pressed to 45% of the initial volume and the pressed plate was heated by means of contact heat to about 80° C., the temperature was maintained for about 2 hours, the plate was subsequently removed from the mold and matured until the weight was constant.

| | | As in example 1 | |
|---|---|---|---|
| | | but without | |
| Parameter | Dimension | Expancel ® grades | Example 1 |
| Density | g/l | 65 | 52 |
| Test A | % by volume | 2.2 | 9.2 |
| Test B | % by weight | 3.9 | 5.1 |
| Test C | % by volume | 5.8 | 6.2 |
| Test D min | min | 69 | 80 |
| Lamda | mW/m*K | 39.7 | 35.9 |
| Compressive strength | MPa | 7.1 | 4.7 |
| Flexural strength | MPa | 22 | 19 |

### Example 2

A mixture of kaolin (1347 g), water glass (575 g), Acronal S790 Dispersion (575 g), Wollastonite HW 7 (1347 g), Betolin (1732 g), Levasil 50/50 (1732 g), Expancel 551WE (97 g), Expancel 820SLU (386 g), deionized water (600 g) was made up. After complete homogenization, 7790 g of this coating mixture were added to 3970 g of prefoamed EPS spheres (density 10 g/l) and mixed well. The spheres which have been coated in this way were subsequently introduced into a mold, pressed to 45% of the initial volume and the pressed plate was hardened by means of microwave radiation. The microwaves were operated as follows:
1500 watt: 15 minutes
1300 watt: 20 minutes
900 watt 5 minutes

No irradiation pause was provided.

| | | Example 2 | |
|---|---|---|---|
| | | but without | |
| Parameter | Dimension | Expancel ® grades | Example 2 |
| Density | g/l | 65 | 52 |
| Test A | % by volume | 2.2 | 8.7 |
| Test B | % by weight | 3.9 | 5.6 |
| Test C | % by volume | 5.8 | 6.7 |
| Test D min | min | 69 | 83 |
| Lamda | mW/m*K | 39.7 | 35.8 |
| Compressive strength | MPa | 7.1 | 4.8 |
| Flexural strength | MPa | 22 | 19 |

1-14. (canceled)

15. A foam particle coated with a combination of a silicate-comprising coating, hollow microspheres and optionally nanosize SiO₂ particles.

16. The foam particle of claim 15, wherein the foam particle is selected from the group consisting of a polyolefin and a styrene polymer.

17. The foam particle according to claim 16, wherein the particle is an expandable polyolefin particle or a foamed particle of expandable styrene polymers (EPS).

18. The foam particle according to claim 15, wherein the coating comprises from 20 to 60 parts by weight of hollow microspheres per 100 parts by weight of the silicate-comprising coating.

19. The foam particle according to claim 15, wherein the coating is based on a coating composition comprising
a) from 20 to 70% by weight of a clay mineral,
b) from 20 to 70 parts by weight of an alkali metal silicate
c) from 1 to 30 parts by weight of a film-forming polymer
m) from 20 to 60, in particular from 25 to 40, parts by weight of hollow microspheres and optionally further constituents.

20. The foam particle according to claim 19, wherein a water-soluble alkali metal silicate having the composition M2O(SiO2)n, where M=sodium or potassium and n=1 to 4, or a mixture thereof is comprised as alkali metal silicate.

21. The foam particle according to claim 19, wherein the film-forming polymer is based on ethylenically unsaturated monomers having a glass transition temperature in the range from −30 to 80° C.

22. The foam particle according to claim 15, wherein the hollow microspheres comprise a mixture of expanded and unexpanded hollow microspheres.

23. The foam particle according to claim 15, wherein the hollow microspheres are produced on the basis of acrylic acid or an acrylate and a blowing agent.

24. The foam particle according to claim 15, wherein the hollow microspheres consist essentially of an acrylate-methacrylate copolymer with isopentane as blowing agent.

25. A process for producing coated foam particles according to claim 15, wherein a coating composition comprising a silicate-comprising coating, hollow microspheres and optionally nanosize SiO₂ particles is applied in the form of an aqueous dispersion to foam particles.

26. The process according to claim 25 wherein the coating composition additionally comprises a film-forming polymer.

27. A process for producing foam moldings, which comprises the following steps:
a) introduction of the coated foam particles according to claim 15 into a mold, pressing of the coated foam particles and drying, if appropriate with the aid of reduced pressure, and
b) sintering.

28. A foam molding which can be obtained according to claim 27.

29. A method of using foam moldings comprising:
providing the foam molding according to claim 28; and
utilizing the foam molding as sandwich panels, for exterior wall insulation, for roof applications, for fire latches and fire doors.
